(19) United States
(12) Patent Application Publication
(10) Pub. No.: US 2009/0252848 A1
(43) Pub. Date: Oct. 8, 2009

(54) Immunomodulating polysaccharide gel from durian fruit-rind as additive in animal feed

(76) Inventors: Sunanta Pongsamart, Patumwam (TH); Niwat Chansiripornchai, Patumwam (TH); Piyarat Chansiripornchai, Patumwan (TH); Komsil Poldang, Patumwam (TH)

Correspondence Address: Dr. Sunanta Pongsamart;Faculty of Pharmaceutical Sciences, Chulalongkorn University, Phyathai Rd., Patumwan, 10330, TH

(21) Appl. No.: 12/080,281

(22) Filed: Apr. 3, 2008

(51) Int. Cl. A23K 1/00; A23K 1/18; A23K 1/16; A23L 1/06

(52) U.S. Cl. 426/573

(57) ABSTRACT

A water-soluble polysaccharide gel having good immuno-stimulating activity was extracted from fruit-rind of durian (Durio zibethinus Murr.) Food supplement having immuno-stimulating activity for feeding black tiger shrimp or chicken were prepared using the polysaccharide gel isolated from durian fruit-rind.

### BACKGROUND OF THE INVENTION

This invention relates to immunomodulating preparation from polysaccharide gel extracted from durian rind as additive in animal feed.

The natural polysaccharides isolated from dried fruit-rind of durian are high-molecular weight polysaccharides present in fruit-rind of durian. Polysaccharides are usually defined as polymers of carbohydrate from plant cell. It has great industrial potential due to its useful physical and chemical properties with advantageous biological activities. Potential future applications of polysaccharides are food additives, thickeners, stabilizer, disintegrator, binder, emulsifiers, gelling agents, film-forming agent, adhesives, and adsorbents. Improved immune response in black tiger shrimp or chicken after feeding durian polysaccharide gel (PG) as well as antibacterial activity of PG have been reported. This would be useful as decrease in use of chemotherapeutic agents to protect shrimp or chicken against bacterial or viral infection is possible adding PG in the diet. This makes use of durian rind, normally a great burden to get rid of, to become of great value economically leading to increase productivity of aquaculture, i.e., black tiger shrimp, as well as livestock especially chicken by protection against various pathogenic microorganisms.

### SUMMARY OF THE INVENTION

A water-soluble polysaccharide gel was extracted from fruit-rind of durian (Durio zibethinus Murr.) and used as additive to diet feeding black tiger shrimp culture or animal feed especially chicken. Adding the polysaccharide gel in feed results in activating immunogenic performance and greater survival rate of black tiger shrimp culture against white spot syndrome virus (WSSV) or bacterium Vibrio harveyi and also increasing hemagglutination-inhibition antibody titers against Newcastle Disease in chicken.

### BRIEF DESCRIPTION OF THE DRAWING

FIG. 1 shows survival rate of Penaeus monodon juvenile on challenge test with WSSV, 106(1:100) by cohabitation method after 4 weeks feeding period with shrimp diets containing various concentrations of PG.

### DETAILED DESCRIPTION OF THE PREFERRED EMBODIMENTS

Polysaccharide gel was extracted from dried fruit-rind of durian (Durio zibethinus Murr.) a plant cultivated in Thailand according to method described by Pongsamart and Pamnaung (Songkhlanakarin J Sci Technol. (1998), 20 (3), 323-332). where the gel is extracted from dried fruit-rind of durian comprises steps of mild boiling dried fruit rind in 25-30 volume of water for 40 minutes, filtering, repeating mild boiling residue 1-2 times with 15 volume by weight of water, pooling of filtrates and concentrating by rotary evaporating at 70° C. under reduced pressure and precipitating using acidified aqueous ethanol, collecting precipitate, drying and pulverizing or spray-drying. Polysaccharide gel is characterized to be pectic polysaccharide with immunomodulating activity according to Hokputsa et al. (2004) (Carbohydrate Polymers (2004) 56:471-481).

The gel itself was found to possess good antibacterial activity against various microorganisms i.e. Staphylococcus aureus, Staphylococcus epidermidis, Micrococcus luteus, Bacillus subtilis, Escherichia coli, and Lactobacillus pentosus (Pongsamart et al (2005), Acta Horticulturae 678, 65-73). This polysaccharide gel is water-soluble and has good physical property which makes it possible for use pharmaceutically as stabilizing agent, thickening agent and film-forming agent, in addition to its desirable gelling property. Aquaculture has now been globally expanded to cope with the ever growing requirements for increasing world food supplies. Many attempts have been made to increase productivity of aquaculture, i.e. shrimps, as well as livestock especially chicken. Better productivity can be achieved by better growing results in better weight gain:food intake ratio. Protection of the shrimp culture against various pathogenic microorganisms, especially white spot syndrome virus (WSSV) and bacterium Vibrio harveyi, would also increase the productivity and is one of the normal practice in aquaculture. Previous manipulation on this regard by use of various antibiotics leads to great increase on cost of production, in addition to the objection of consumer concerning about the residue antibiotics remained in the commercially available product either in aquaculture, livestock or dairy which can be harmful to health. Seek for natural anti-microorganisms or immune-stimulating agent has been extensively undergone. Supamattaya et al. (Songklanakarin J Sci Technol 2000, 22(Suppl.), 677-687) have reported higher bacterial clearance ability of shrimp than that of control group after 11 week-feeding shrimp food supplemented with 0.25, 0.50 or 1.0 g/kg of β-glucan (Macrogard®). Thus, disease resistance in black tiger shrimp increased after feeding shrimp food supplemented with certain polysaccharide. Polysaccharide gel from durian fruit rind added as feed supplement for broiler chicken has been shown to elevate stimulation of immune response to Newcastle Disease (ND). The present invention describes supplementation of animal food with polysaccharide gel isolated from durian fruit rind which helps stimulating immune response in shrimp and chicken.

### Example 1

Shrimp Feed Supplemented with Polysaccharide Gel (PG) (% by Weight)

| | |
|---|---|
| Protein | 35-45% |
| Fat | 3-6% |
| Carbohydrate | 30-40% |
| Vitamins and minerals | 2-3% |
| PG | 0.5-3% |
| Diluent | q.s. ad |

### Example 2

Shrimp Feed Supplemented with Polysaccharide Gel (PG) (% by Weight)

| | |
|---|---|
| Protein | 40% |
| Fat | 6% |
| Carbohydrate | 36% |
| Vitamins and minerals | 3% |
| PG | 1-2% |
| Diluent | q.s. ad |

### Example 3

Chicken Feed Supplemented with Polysaccharide Gel (PG) (% by Weight)

| | |
|---|---|
| Protein | 20-30% |
| Fat | 3-6% |
| Carbohydrate | 25-40% |
| Vitamins and minerals | 5-10% |
| PG | 0.5-4% |
| Diluent | q.s. ad |

### Example 4

Chicken Feed Supplemented with Polysaccharide Gel (PG) (% by Weight)

| | |
|---|---|
| Protein | 22% |
| Fat | 4.5% |
| Carbohydrate | 40% |
| Vitamins and minerals | 8% |
| PG | 0.5-3% |
| Diluent | q.s. ad |

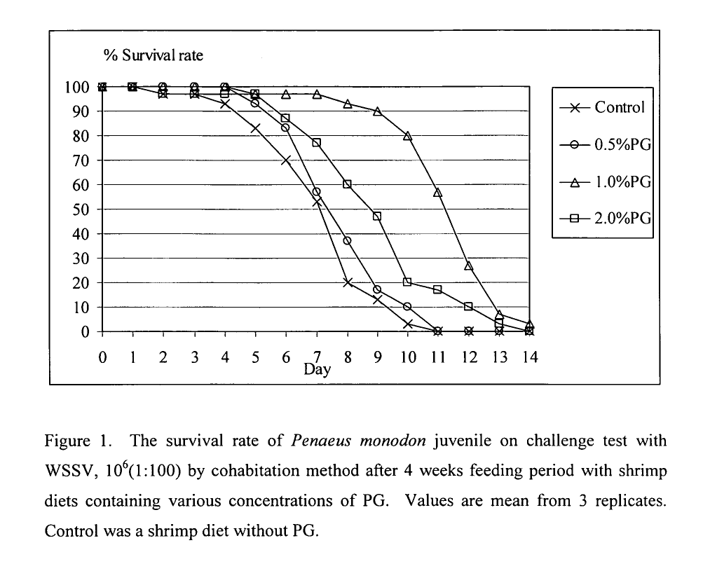

Table 1. and FIG. 1. show that upon challenge test with white spot syndrome virus (WSSV), black tiger shrimp (Penaeus monodon) fed PG supplemented 0.5-2% diet increased survival rate compared to control of 0% PG diet. Effect of polysaccharide gel (PG) which improved immunogenic performance of Penaeus monodon juvenile after 8 weeks feeding period is shown in Table 2. Result in Table 3. indicates protection against Vibrio harveyi 1526, a major disease of shrimp crop, by supplementation of PG in shrimp feed leading to increase in relative percent survival (RPS) of P. monodon juvenile shrimp challenged by immersion method.

Effect of PG-supplemented feed on chicken which increases Hemagglutination-Inhibition (HI) antibody titers against Newcastle Disease (ND) was shown in Table 4.

It will be understood that modifications can be made in the above description without departing from the scope of this invention by one of ordinary skill in the art. It is accordingly intended that all matter contained in the above description be interpreted as descriptive and illustrative rather than in a limiting sense. It is also to be understood that the following claims are intended to cover all of the generic and specific features of the invention as described herein, and all statements of the scope of the invention which, as a matter of language, might be said to fall therebetween.

TABLE 1
The survival rate of black tiger shrimp (Penaeus momodon) on challenge
test with white spot syndrome virus (WSSV), 10⁶ (1:100 dilution) by
cohabitation method after 8 weeks feeding period, using three groups of
the rearing shrimp (24 shrimp/group) in each treatments. Values are
mean ± SD. Control = 0% PG.

| | The survival rate of black tiger shrimp | | | |
|---|---|---|---|---|
| | with different concentration of PG. (%) | | | |
| Date | Control | 0.5% PG | 1.0% PG | 2.0% PG |
| 0 | 100 ± 0.00 | 100 ± 0.00 | 100 ± 0.00 | 100 ± 0.00 |
| 1 | 100 ± 0.00 | 100 ± 0.00 | 100 ± 0.00 | 100 ± 0.00 |
| 2 | 100 ± 0.00 | 100 ± 0.00 | 100 ± 0.00 | 100 ± 0.00 |
| 3 | 100 ± 0.00 | 100 ± 0.00 | 100 ± 0.00 | 100 ± 0.00 |
| 4 | 100 ± 0.00 | 100 ± 0.00 | 100 ± 0.00 | 100 ± 0.00 |
| 5 | 100 ± 0.00 | 100 ± 0.00 | 83 ± 1.15 | 96 ± 0.58 |
| 6 | 100 ± 0.00 | 96 ± 0.58 | 58 ± 3.06 | 83 ± 2.31 |
| 7 | 100 ± 0.00 | 96 ± 0.58 | 54 ± 3.21 | 75 ± 3.46 |
| 8 | 88 ± 0.00 | 92 ± 1.15 | 42 ± 4.04 | 71 ± 4.04 |
| 9 | 79 ± 0.58 | 67 ± 2.08 | 33 ± 4.62 | 71 ± 4.04 |
| 10 | 54 ± 0.58 | 38 ± 2.65 | 25 ± 3.46 | 58 ± 4.16 |
| 11 | 42 ± 1.15 | 21 ± 2.89 | 13 ± 1.73 | 50 ± 3.61 |
| 12 | 21 ± 1.15 | 21 ± 2.89 | 8 ± 1.15 | 46 ± 3.51 |
| 13 | 4 ± 0.58 | 17 ± 2.31 | 4 ± 0.58 | 38 ± 3.61 |
| 14 | 0 ± 0.00 | 4 ± 0.58 | 4 ± 0.58 | 33 ± 3.79 |

TABLE 2
Effect of polysaccharide gel (PG) on immunogenic performance of Penaeus
monodon juvenile after 8 weeks feeding period, each treatment using
four groups of shrimp (100 shrimps/group).

| | | Effect of immunogenesis in shrimp after feeding with | | | |
|---|---|---|---|---|---|
| | Shrimp | shrimp diets with different concentration of PG. | | | |
| | number | (mean ± SD) | | | |
| Tests | (n) | Control | 0.5% PG | 1.0% PG | 2.0% PG |
| 1. Total hemocyte count | 12 | ^{c}1.16 ± 0.45 | ^{bc}1.20 ± 0.45 | ^{ab}1.56 ± 0.43 | ^{a}1.68 ± 0.57 |
| (×10⁷ cell/mm³) | | | | | |
| 2). Phenoloxidase | 12 | ^{b}609.37 ± 117.71 | ^{b}705.99 ± 208.97 | ^{a}900.11 ± 281.85 | ^{a}893.30 ± 252.58 |
| activity | | | | | |
| (units/mins/mg. protein) | | | | | |

Values are mean ± SD.
Control = 0% PG.
^{a,b,c}= significant difference between groups (p < 0.05).

TABLE 3
Relative percent survival (RPS) of P. monodon juvenile shrimp
challenged by immersion method with Vibrio harveyi 1526.
Cumulative mortality and RPS values were determined
at day 3 of infection after 8 weeks feeding.

| | Mean of | Mortality | |
|---|---|---|---|
| Shrimp group | dead shrimp/n | (%) | RPS (%) |
| Control | 4.0/8 | 50 | 0 |
| 0.5% PG | 3.3/8 | 41 | 18 |
| 1.0% PG | 2.7/8 | 34 | 32 |
| 2.0% PG | 2.0/8 | 25 | 50 |

Control = 0.0% PG.
n = number of shrimp tested per replication.

TABLE 4
Effect of PG-supplemented chicken feed on Hemagglutination-
Inhibition (HI) antibody titers against Newcastle Disease (ND)

| PG supplemented | HI antibody titers (Log2) | | |
|---|---|---|---|
| (%) | 14-day-old | 28-day-old | 38-day-old |
| 0 | 2.3 ± 0.9 | 1.3 ± 0.7 | 3.0 ± 1.0 |
| 0.5 | 3.0 ± 0.6 | 2.7 ± 2.0 | 3.7 ± 1.7 |
| 1.5 | 2.5 ± 0.9 | 2.7 ± 1.4 | 3.5 ± 0.8 |
| 3.0 | 3.3 ± 1.1 | 1.2 ± 0.4 | 2.7 ± 1.2 |

We claim:

1. A water-soluble polysaccharide gel to be used as immunomodulating agent where it is extracted from dried fruit-rind of durian comprises steps of mild boiling dried fruit rind in 25-30 volume of water for 40 minutes, filtering, repeating mild boiling residue 1-2 times with 15 volume by weight of water, pooling of filtrates and concentrating by rotary evaporating at 70° C. under reduced pressure and precipitating using acidified aqueous ethanol, collecting precipitate, drying and pulverizing or spray-drying.

2. Aquaculture feed, especially black tiger shrimp feed, with immunomodulating activity having polysaccharide gel of claim 1. in the amount of 0.5 to 3% by weight.

3. Livestock feed, especially chicken feed, with immunomodulating activity having polysaccharide gel of claim 1. in the amount of 0.5 to 4% by weight.
